(19) United States
(12) Patent Application Publication
(10) Pub. No.: US 2023/0064853 A1
(43) Pub. Date: Mar. 2, 2023

(54) FLUORINE-CONTAINING ELASTOMER COMPOSITION AND SEALING MATERIAL

(71) Applicant: AIR WATER MACH INC., Nagano (JP)

(72) Inventor: Ai KURATA, Nagano (JP)

(21) Appl. No.: 17/794,280

(22) PCT Filed: Apr. 3, 2020
(86) PCT No.: PCT/JP2020/015300

§ 371 Date: Jul. 21, 2022

(30) Foreign Application Priority Data
Jan. 28, 2020 (JP) 2020-011327

(51) Int. Cl. C08K 3/36; C08F 114/22

(52) U.S. Cl. CPC C08K 3/36; C08F 114/22; C08K 2201/003; C08K 2201/011

(57) ABSTRACT

This fluorine-containing elastomer composition contains a fluorine-containing elastomer and a filler that has a particle diameter of from 10 nm to 100 nm. The fluorine-containing elastomer is a perfluoro elastomer or a fluorine rubber. The filler is composed of silicon particles, and silicon particles each having an oxide film. This fluorine-containing elastomer composition contains no other substance as a filler.

### FIELD

The present invention relates to a fluorine-containing elastomer composition blended with a filler. In addition, the present invention relates to a sealing material including the fluorine-containing elastomer composition.

### BACKGROUND

At semiconductor production processes, plasma irradiation is performed during etching treatment or the like to silicon wafers under an oxygen or fluorocarbon-based gas atmosphere. Therefore, plasma resistance properties are required to a sealing material used for an apparatus for semiconductor production such as an etching apparatus. Specifically, as the plasma resistance properties, it is required that generation of particles due to surface deterioration caused by the plasma irradiation can be reduced and weight loss due to vaporization and damage of the composition materials caused by the plasma irradiation can be reduced.

As a sealing material that can reduce mass loss under plasma irradiation environments, a fluorine-containing elastomer composition blended with silica particles in a fluorine-containing elastomer has been known. Such a sealing material is described in Patent Literature 1.

### CITATION LIST

### Patent Literature

Patent Literature 1: Japanese Patent Application Laid-open No. 2002-371158

### SUMMARY

### Technical Problem

The fluorine-containing elastomer compositions blended with the silica particles, however, have a problem in that the silica particles are aggregated and thus constituted materials drop off to generate particles as the surface deteriorates due to the plasma irradiation.

In view of such a problem, an object of the present invention is to provide a fluorine-containing elastomer composition and a sealing material that can reduce generation of the particles as close to zero as possible while the mass loss under the plasma irradiation environment is being reduced.

### Solution to Problem

In order to solve the above problem, the fluorine-containing elastomer composition according to the present invention includes a fluorine-containing elastomer and a filler having a particle diameter of 10 nm or more and 100 nm or less, in which the filler is silicone particles.

Here, the silicon particles blended as the filler is likely to bond to oxygen. Therefore, handing of the silicon particles for producing the fluorine-containing elastomer composition may cause the surface of the silicon particles to be oxidized. Namely, an oxide film may be formed at the surface of the silicon particles used as the filler. In such a case, the fluorine-containing elastomer composition includes the silicon particles of which surface is not oxidized and the silicon particles including the oxide film. In other words, the fluorine-containing elastomer composition in another form of the present invention includes a fluorine-containing elastomer and a filler having a particle diameter of 10 nm or more and 100 nm or less, in which the filler is silicon particles and silicon particles including an oxide film.

Subsequently, the present invention can include a sealing material including the fluorine-containing elastomer composition.

### DESCRIPTION OF EMBODIMENTS

Hereinafter, the fluorine-containing elastomer composition and the sealing material that are the embodiments of the present invention will be described.

### (Fluorine-Containing Elastomer Composition)

The fluorine-containing elastomer composition of this example includes the fluorine-containing elastomer and the filler.

As the fluorine-containing elastomer, a fluororubber may be used. For example, the fluororubber is a vinylidene fluoride-based rubber. As the fluorine-containing elastomer, a fluorine-containing silicone-based elastomer and a perfluoroelastomer may be used.

The filler has a particle diameter of 10 nm or more and 100 nm or less. The filler is the silicon particles and the silicon particles including the oxide film. The silicon particles including the oxide film may refer to silicon particles in which the film of silicon oxide is formed at the silicon particle surface. Here, in the fluorine-containing elastomer composition, no fillers other than these silicon particles are included as the filler. Namely, silica particles, silicon carbide particles, alumina particles, and the like are not included in the fluorine-containing elastomer composition. The blend proportion of the silicon particles and the silicon particles including the oxide film is not particularly limited. The part(s) by weight of the silicon particles including the oxide film is preferably smaller than the parts by weight of the silicon particles.

In this example, 1 part by weight to 20 parts by weight of the filler is blended relative to 100 parts by weight of the fluorine-containing elastomer composition. Here, in the case where the amount of the filler is larger than 20 parts by weight, the rubber properties of the fluorine-containing elastomer composition may deteriorate. For example, an increase in the blended amount of the filler relative to the fluorine-containing elastomer composition causes the elasticity of the fluorine-containing elastomer composition to be lowered and thus the fluorine-containing elastomer composition becomes harder. Consequently, in the case where the amount of the filler is larger than 20 parts by weight, the fluorine-containing elastomer composition may become excessively hard as compared to the fluorine-containing elastomer. Here, excessively hard fluorine-containing elastomer composition causes the sealing material to be excessively hard, for example, in the case where the fluorine-containing elastomer composition is used as the sealing material, resulting in deteriorating the sealing properties of the sealing material.

Additives may be further blended in the fluorine-containing elastomer composition. The additives are additives for cross-linking, antioxidants, or processing aids.

### (Sealing Material)

The sealing material refers to a packing, a gasket, an O-ring, and the like. The sealing material is made by forming the fluorine-containing elastomer composition into a predetermined shape. At the time of forming the sealing material into a desired shape, an additive for cross-linking may be further blended in the fluorine-containing elastomer composition.

### (Method for Producing Fluorine-Containing Elastomer Composition)

The fluorine-containing elastomer composition is obtained by vulcanizing a kneaded product made by kneading the fluorine-containing elastomer, the filler, and the additives.

Specifically, the fluorine-containing elastomer is charged into an open roll machine to wrap the fluorine-containing elastomer around the rolls. Subsequently, the filler and the additives are charged into the open roll machine and the resultant mixture is kneaded until the filler and the additives are dispersed in the fluorine-containing elastomer. Thereafter, the kneaded product made by kneading the fluorine-containing elastomer, the filler, and the additives is taken out from the open roll machine and cut so as to be a predetermined weight.

Subsequently, the cut kneaded product is subjected to primary vulcanization. In the primary vulcanization, the cut kneaded product is placed in a preheated mold and press-molded while being heated. Thereafter, secondary vulcanization is performed. In the secondary vulcanization, the molded product after the primary vulcanization is charged in an oven and heated at a higher temperature and for a longer time than those of the primary vulcanization. This allows the fluorine-containing elastomer composition to be obtained.

### DESCRIPTION OF EXAMPLES AND COMPARATIVE EXAMPLES

Hereinafter, the fluorine-containing elastomer compositions in Examples 1 and 2, to which the present invention is applied, will be described. In addition, the fluorine-containing elastomer compositions in Comparative Examples 1 to 4 will be described.

### Example 1

With respect to the fluorine-containing elastomer composition in Example 1, a perfluoroelastomer is used as the fluorine-containing elastomer. The filler is silicon particles and silicon particles including an oxide film. The particle diameter of the filler is 10 nm or more and 100 nm or less. In this Example, the average particle diameter of the filler is 40 nm to 50 nm. The amount of the filler is 10 parts by weight relative to 100 parts by weight of the perfluoroelastomer.

The additives are cross-linking agents. Peroxide cross-linking agent and co-cross-linking agent are used as the cross-linking agents. The peroxide cross-linking agent is 2,5-dimethyl-2,5-bis(t-butylperoxy)hexane (Perhexa 25B, manufactured by NOF CORPORATION). The co-crosslinking agent is triallyl isocyanurate (TRIC, manufactured by Mitsubishi Chemical Corporation). The amount of cross-linking agent is 0.76 part by weight relative to 100 parts by weight of the perfluoroelastomer. More specifically, the amount of the peroxide cross-linking agent is 0.33 part by weight relative to 100 parts by weight of the perfluoroelastomer. The co-crosslinking agent is 0.43 parts by weight per 100 parts by weight of the perfluoroelastomer. The temperature of the primary vulcanization is 150° C. and the vulcanization time is 20 minutes. The temperature of the secondary vulcanization is 230° C. and the vulcanization temperature is 4 hours.

### Example 2

With respect to the fluorine-containing elastomer composition in Example 2, a vinylidene fluoride-based rubber is used as the fluorine-containing elastomer. The filler is the silicon particles and the silicon particles including the oxide film. The filler and the additives are the same as those in Example 1. Namely, the particle diameter of the filler is 10 nm or more and 100 nm or less. In this Example, the average particle diameter of the filler is 40 nm to 50 nm. The amount of the filler is 10 parts by weight relative to 100 parts by weight of the vinylidene fluoride-based rubber. The additives are cross-linking agents. The peroxide cross-linking agent and the co-cross-linking agent are used. The amount of the cross-linking agent is 4.4 parts by weight relative to 100 parts by weight of the vinylidene fluoride-based rubber. In detail, the peroxide cross-linking agent is 1.4 parts by weight relative to 100 parts by weight of perfluoroelastomer. The amount of the co-crosslinking agent is 3 parts by weight relative to 100 parts by weight of perfluoroelastomer. The temperature of the primary vulcanization is 160° C. and the vulcanization time is 10 minutes. The temperature of the secondary vulcanization is 200° C. and the vulcanization temperature is 4 hours.

### Comparative Examples 1 and 2

With respect to the fluorine-containing elastomer compositions in Comparative Example 1, the perfluoroelastomer is used as the fluorine-containing elastomer and the silica particles are used as the filler. With respect to the fluorine-containing elastomer compositions in Comparative Example 2, the vinylidene fluoride-based rubber is used as the fluorine-containing elastomer and the silica particles are used as the filler. In Comparative Examples 1 and 2, the average particle diameter of the silica particles used as the filler is about 5 μm. The filler is different between Example 1 and Comparative Example 1, but the other formulations and vulcanization conditions are the same. The filler is different between Example 2 and Comparative Example 2, but the other formulations and vulcanization conditions are the same.

### Comparative Examples 3 and 4

With respect to the fluorine-containing elastomer composition in Comparative Example 3, the perfluoroelastomer is used as the fluorine-containing elastomer and the no filler is added. With respect to the fluorine-containing elastomer compositions in Comparative Example 4, the vinylidene fluoride-based rubber is used as the fluorine-containing elastomer and no filler is added. The other formulations and vulcanization conditions of Example 1 and Comparative Example 3 are the same except that the filler is blended or not. The other formulations and vulcanization conditions of Example 2 and Comparative Example 4 are the same except that the filler is blended or not.

Table 1 below lists the normal properties of each of the fluorine-containing elastomer compositions in Example 1 and Example 2. The normal physical properties of each of the fluorine-containing elastomer compositions were measured by preparing a test specimen having a dumbbell-like No. 3 shape from each of the fluorine-containing elastomer compositions as specified in the JIS standard (JIS K6251). Hardness was measured in accordance with JIS standard (JIS K6253). Tensile strength, elongation at break, and tensile stress at predetermined elongation were measured in accordance with JIS standards (JIS K6251). The tensile stress at predetermined elongation may also be represented as 100% modulus.

TABLE 1

| (Unit) | Example 1 | Example 2 |
|---|---|---|
| Hardness (Durometer A) | 90 | 73 |
| Tensile strength (MPa) | 15.8 | 22.1 |
| Elongation at break (%) | 100 | 210 |
| Tensile stress at predetermined | 15 | 4.3 |
| elongation (MPa) | | |

Table 2 below lists the normal properties of each of the fluorine-containing elastomer compositions in Examples 1 to 4.

TABLE 2

| | Com- | Com- | Com- | Com- |
|---|---|---|---|---|
| | parative | parative | parative | parative |
| | Ex- | Ex- | Ex- | Ex- |
| | ample | ample | ample | ample |
| (Unit) | 1 | 2 | 3 | 4 |
| Hardness (Durometer A) | 85 | 72 | 70 | 57 |
| Tensile strength (MPa) | 20.3 | 20.9 | 27.8 | 7.4 |
| Elongation at break (%) | 180 | 300 | 210 | 270 |
| Tensile stress at | 6.5 | 3.3 | 3.4 | 1.1 |
| predetermined | | | | |
| elongation (MPa) | | | | |

### (Plasma Resistance Properties)

Subsequently, the plasma resistance properties of the fluorine-containing elastomer composition in Example 1 will be described. The plasma resistance properties are evaluated by a plasma irradiation test using the samples. In addition, as the plasma resistance properties, it is evaluated that the weight loss of the samples under a plasma irradiation environment can be reduced and the generation of particles due to the plasma irradiation can be reduced.

The samples used for the plasma irradiation test are O-rings (sealing materials) made of each of fluorine-containing elastomer compositions in Example 1, Example 2, and Comparative Examples 1 to 4. Therefore, the plasma resistance properties of the fluorine-containing elastomer composition are the plasma resistance properties of the sealing material. The size of the O-ring is P-25 as specified in the JIS standard (JIS B2401).

The plasma irradiation test is performed using a dry etching apparatus. In the plasma irradiation test, the sample is weighed by an electronic balance before the plasma irradiation. Subsequently, the sample is placed in the dry etching apparatus and the plasma irradiation is performed. The plasma irradiation is performed under two kinds of gas atmospheres. The gas species used under the first gas atmosphere is a CF₄/O₂ gas mixture. The proportion of CF₄ to O₂ in the gas mixture is 1:10. The gas species used under the second gas atmosphere is an O₂ single gas. In both gas atmospheres, the gas flow rate is 50 cc/min. The RF power is 200 W. The degree of vacuum is 0.1 Torr. The plasma irradiation time is 90 minutes.

After the plasma irradiation, the sample is taken out from the dry etching apparatus and the first weight measurement is performed. Subsequently, the surface of the sample is wiped with a towel wetted with distilled water and the second weight measurement is performed. Namely, particles attached to the surface of the sample are removed after the first weight measurement and the second weight measurement is performed.

The difference between the weight of the sample before the plasma irradiation and the first measurement value obtained by the first weight measurement is a gasification weight. Namely, the gasification weight refers to the weight of the filler and other materials gasified under the plasma irradiation environment. The difference between the weight of the sample before plasma irradiation and the second measurement value obtained by the second weight measurement is a changed value of the sample weight changed by the plasma test. The difference between the first measurement value and the second measurement value is the weight of the generated particles.

The results of the plasma irradiation test are listed in Table 3 and Table 4 below. Table 3 lists the results in the case where the plasma irradiation is performed under the CF₄/O₂ gas mixture environment. Table 3 lists the results in the case where the plasma irradiation is performed under the O₂ single gas environment. In Table 3 and Table 4, a weight change rate is the proportion of the weight change value of the sample when the weight of the sample before plasma irradiation is determined to be 100. The weight of the sample decreases after the plasma irradiation and thus the weight change rate is represented as a negative value. The proportion of the gasification weight is the proportion of the gasification weight when the total weight is determined to be 100. The proportion of the generated particle weight is the proportion of the particle weight when the total weight is determined to be 100.

TABLE 3

| | | Proportion | Proportion of |
|---|---|---|---|
| | Weight | of | generated |
| | change | gasification | particle |
| Under CF₄/O₂ gas | rate | weight | weight |
| mixture environment | (%) | (%) | (%) |
| Example 1 | −1.9 | 100.0 | 0.0 |
| Example 2 | −3.0 | 100.0 | 0.0 |
| Comparative Example 1 | −2.5 | 99.3 | 0.7 |
| Comparative Example 2 | −3.0 | 99.6 | 0.4 |
| Comparative Example 3 | −3.5 | 99.8 | 0.2 |
| Comparative Example 4 | −6.3 | 99.8 | 0.2 |

TABLE 4

| | Weight | Proportion of | Proportion of |
|---|---|---|---|
| | change | gasification | generated particle |
| Under O₂ single | rate | weight | weight |
| gas environment | (%) | (%) | (%) |
| Example 1 | −2.5 | 100.0 | 0.0 |
| Example 2 | −2.9 | 100.0 | 0.0 |
| Comparative Example 1 | −3.4 | 99.2 | 0.8 |
| Comparative Example 2 | −3.3 | 99.4 | 0.6 |
| Comparative Example 3 | −4.8 | 100.0 | 0.0 |
| Comparative Example 4 | −6.6 | 100.0 | 0.0 |

First, as can be seen from Table 3 and Table 4, the weight change rates of the fluorine-containing elastomer compositions in Comparative Examples 3 and 4, in which the filler is not blended, are large in both plasma irradiation under the CF₄/O₂ gas mixture atmosphere and plasma irradiation under the O₂ single gas atmosphere. Namely, the reduction in the weight loss under the plasma irradiation environment is insufficient. Therefore, the fluorine-containing elastomer compositions in Comparative Examples 3 and 4, in which the filler is not blended, have low plasma resistance properties.

In contrast, as can be seen from Table 3 and Table 4, the weight losses under the plasma irradiation environment are sufficiently reduced in Examples 1 and 2 and Comparative Examples 1 and 2, in which the filler is blended.

As listed in Table 3, the weight loss in Example 1 is more reduced than that of Comparative Example 1 under the plasma irradiation environment of the CF₄/O₂ gas mixture atmosphere. Under the plasma irradiation environment of the CF₄/O₂ gas mixture atmosphere, the weight loss in Example 2 is equal to that of Comparative Example 2. Therefore, with respect to the fluorine-containing elastomer compositions including the same polymer component as the fluorine-containing elastomer, blend of the silicon particles and the silicon particles including the oxide film as the filler allows the weight loss to be reduced to the same as or even more than the case where the silica particles are blended as the filler.

In addition, as listed in Table 4, under the plasma irradiation environment of the O₂ single gas atmosphere, the weight losses of the samples in Examples 1 and 2 according to the present invention, in which the silicon particles and the silicon particles including the oxide film are blended as the filler, can be more reduced than the weight losses in Comparative Examples 1 and 2, in which the silica particles are blended as the filler.

In addition to this, as listed in Table 3 and Table 4, the fluorine-containing elastomer compositions in Example 1 and Example 2 did not generate particles or generation of the particles could not be detected after any of the plasma irradiation under the CF₄/O₂ gas mixture atmosphere and the plasma irradiation under the O₂ single gas atmosphere. In contrast, in Comparative Examples 1 and 2, in which silica particles were blended in the fluorine-contained elastomer, generation of the particles was observed.

Here, the particle diameter of the filler is the primary particle diameter. In the present invention, the particle diameter of the filler refers to the average particle diameter of the filler blended in the fluorine-contained elastomer. The average particle diameter of the filler can be acquired by calculating the specific surface area using an automatic specific surface area and pore distribution measurement apparatus (BELSORP (registered trademark) mini II, manufactured by BEL JAPAN, INC.).

### Examples 3 to 5

Subsequently, the fluorine-containing elastomer compositions in Examples 3 to 5, to which the present invention is applied, will be described. Similar to Example 1, the fluorine-containing elastomer compositions in Examples 3 to 5 use the perfluoroelastomer as the fluorine-containing elastomer. The filler is the silicon particles and the silicon particles including the oxide film. The particle diameter of the filler is 10 nm or more and 100 nm or less. The average particle diameter of the filler is 40 nm to 50 nm. Examples 3 to 5 differ from Example 1 only in the blend proportion of the filler. In Example 3, the amount of the filler is 1 part by weight relative to 100 parts by weight of perfluoroelastomer. In Example 4, the amount of the filler is 5 parts by weight relative to 100 parts by weight of perfluoroelastomer. In Example 5, the amount of the filler is 20 parts by weight relative to 100 parts by weight of perfluoroelastomer.

Table 5 below lists the normal properties of each of the fluorine-containing elastomer compositions in Examples 3 to 5.

TABLE 5

| (Unit) | Example 3 | Example 4 | Example 5 |
|---|---|---|---|
| Hardness (Durometer A) | 70 | 79 | 93 |
| Tensile strength (MPa) | 21.5 | 21.1 | 19.9 |
| Elongation at break (%) | 260 | 240 | 90 |
| Tensile stress at predetermined | 13.5 | 13.1 | 15 |
| elongation (MPa) | | | |

Subsequently, the results of the plasma irradiation test using O-rings made of each of the fluorine-contained elastomer compositions in Examples 3 to 5 are listed in Table 6 and Table 7 below. Table 6 lists the results in the case where the plasma irradiation is performed under the CF₄/O₂ gas mixture environment. Table 7 lists the results in the case where the plasma irradiation is performed under the O₂ single gas environment. In Table 6 and Table 7, the results of the plasma irradiation test in Comparative Examples 1 and 3, which include the same polymer component as the fluorine-containing elastomers in Examples 3 to 5, are listed together.

TABLE 6

| | Weight | Proportion of | Proportion of |
|---|---|---|---|
| | change | gasification | generated particle |
| Under CF₄/O₂ gas | rate | weight | weight |
| mixture environment | (%) | (%) | (%) |
| Example 3 | −3.0 | 100.0 | 0.0 |
| Example 4 | −2.7 | 100.0 | 0.0 |
| Example 5 | −2.1 | 100.0 | 0.0 |
| Comparative Example 1 | −2.5 | 99.3 | 0.7 |
| Comparative Example 3 | −3.5 | 99.8 | 0.2 |

TABLE 7

| | Weight | Proportion of | Proportion of |
|---|---|---|---|
| | change | gasification | generated particle |
| Under O₂ single | rate | weight | weight |
| gas environment | (%) | (%) | (%) |
| Example 3 | −3.8 | 100.0 | 0.0 |
| Example 4 | −3.1 | 100.0 | 0.0 |
| Example 5 | −2.4 | 100.0 | 0.0 |
| Comparative Example 1 | −3.4 | 99.2 | 0.8 |
| Comparative Example 3 | −4.8 | 100.0 | 0.0 |

As can be seen from the test results of Examples 3 to 5 listed in Table 6 and the test results of Example 1 listed in Table 3 described above, the weight change rates of the fluorine-containing elastomer compositions in Examples 1 and 3 to 5 are smaller than the weight change rate of the fluorine-containing elastomer composition in Comparative Example 3, in which the filler is not blended, in the plasma irradiation under the CF₄/O₂ gas mixture atmosphere. In addition, with respect to the fluorine-containing elastomer compositions in Examples 1 and 3 to 5, particle generation is zero. Therefore, blend of 1 part by weight or more of the filler in this Example relative to 100 parts by weight of the perfluoroelastomer allows the weight loss to be reduced against the plasma irradiation under the CF₄/O₂ gas mixture atmosphere, while the particle generation is being reduced to zero.

As can be seen from the test results of Example 5 listed in Table 6 and the test results of Example 1 listed in Table 3, the weight change rates in the fluorine-contained elastomer compositions in Examples 1 and 5 are smaller than that in the fluorine-containing elastomer composition in Comparative Example 1, in which the silica particles are blended as the filler, in the plasma irradiation under the CF₄/O₂ gas mixture atmosphere. Therefore, blend of the filler in this Example in a proportion of 10 parts by weight or more and 20 parts by weight or less relative to 100 parts by weight of perfluoroelastomer allows the weight loss to be sufficiently reduced against the plasma irradiation under the CF₄/O₂ gas mixture atmosphere, while particle generation is being reduced to zero.

Subsequently, as can be seen from the test results of Examples 3 to 5 listed in Table 7 and the test results of Example 1 listed in Table 4 described above, the weight change rates in the fluorine-containing elastomer compositions in Examples 1 and 3 to 5 are smaller than the weight change rate in the fluorine-containing elastomer composition in Comparative Example 3, in which no filler is blended, in the plasma irradiation under the O₂ gas atmosphere. In addition, with respect to the fluorine-containing elastomer compositions in Examples 1 and 3 to 5, particle generation is zero. Therefore, blend of 1 part by weight or more of the filler in this Example relative to 100 parts by weight of the perfluoroelastomer allows the weight loss to be reduced against the plasma irradiation under the O₂ gas atmosphere, while particle generation is being reduced to zero.

As can be seen from the test results of Examples 4 and 5 and the test results of Example 1, the weight change rates of the fluorine-containing elastomer compositions in Examples 1, 4, and 5 are smaller than that of the fluorine-containing elastomer composition in Comparative Example 1, in which the silica particles are blended as the filler and smaller than that of the fluorine-containing elastomer composition in Comparative Example 3, in which the filler is not blended, in the plasma irradiation under the O₂ gas atmosphere. Therefore, blend of the filler in this Example in a range of 5 parts by weight or more and 20 parts by weight or less relative to 100 parts by weight of the perfluoroelastomer allows the weight loss to be sufficiently reduced against the plasma irradiation under the O₂ gas atmosphere, while particle generation is being reduced to zero.

### Examples 6 to 8

Subsequently, the fluorine-containing elastomer compositions in Examples 6 to 8, to which the present invention is applied, will be described. Similar to Example 2, the fluorine-containing elastomer compositions in Examples 6 to 8 use the fluororubber as the fluorine-containing elastomer. The fluororubber is the polyvinylidene fluoride-based rubber. The filler is the silicon particles and the silicon particles including the oxide film. The particle diameter of the filler is 10 nm or more and 100 nm or less. The average particle diameter of the filler is 40 nm to 50 nm. Examples 6 to 8 differ from Example 2 only in the blend proportion of the filler. In Example 6, the amount of the filler is 1 part relative to 100 parts by weight of the vinylidene fluoride-based rubber. In Example 7, the amount of the filler is 5 parts by weight relative to 100 parts by weight of the vinylidene fluoride-based rubber. In Example 8, the amount of the filler is 20 parts by weight relative to 100 parts by weight of the vinylidene fluoride-based rubber.

Table 8 below lists the normal properties of each of the fluorine-containing elastomer compositions in Examples 6 to 8.

TABLE 8

| (Unit) | Example 6 | Example 7 | Example 8 |
|---|---|---|---|
| Hardness (Durometer A) | 65 | 71 | 89 |
| Tensile strength (MPa) | 14.7 | 14.6 | 14.5 |
| Elongation at break (%) | 300 | 180 | 170 |
| Tensile stress at predetermined | 1.4 | 2.3 | 8.5 |
| elongation (MPa) | | | |

Subsequently, the results of the plasma irradiation test using O-rings made of each of the fluorine-contained elastomer compositions in Examples 6 to 8 are listed in Table 9 and Table 10 below. Table 9 lists the results in the case where the plasma irradiation is performed under the CF₄/O₂ gas mixture environment. Table 10 lists the results in the case where the plasma irradiation is performed under the O₂ single gas environment. In Table 9 and Table 10, the results of plasma irradiation test for the samples in Comparative Examples 2 and 4, which include the same polymer component as the fluorocarbon elastomers in Examples 6 to 8, are listed together.

TABLE 9

| | Weight | Proportion of | Proportion of |
|---|---|---|---|
| | change | gasification | generated particle |
| Under CF₄/O₂ gas | rate | weight | weight |
| mixture environment | (%) | (%) | (%) |
| Example 6 | −5.6 | 100.0 | 0.0 |
| Example 7 | −4.7 | 100.0 | 0.0 |
| Example 8 | −3.0 | 100.0 | 0.0 |
| Comparative Example 2 | −3.0 | 99.6 | 0.4 |
| Comparative Example 4 | −6.3 | 99.8 | 0.2 |

TABLE 10

| | Weight | Proportion of | Proportion of |
|---|---|---|---|
| | change | gasification | generated particle |
| Under O₂ single | rate | weight | weight |
| gas environment | (%) | (%) | (%) |
| Example 6 | −5.3 | 100.0 | 0.0 |
| Example 7 | −4.7 | 100.0 | 0.0 |
| Example 8 | −3.0 | 100.0 | 0.0 |
| Comparative Example 2 | −3.3 | 99.4 | 0.6 |
| Comparative Example 4 | −6.6 | 100.0 | 0.0 |

As can be seen from Table 9, the weight change rates of the fluorine-containing elastomer compositions in Examples 6 to 8 are smaller than that of the fluorine-containing elastomer composition in Comparative Example 4, in which no filler is blended, in the plasma irradiation under the CF₄/O₂ gas mixture atmosphere. In addition, with respect to the fluorine-containing elastomer compositions in Examples 6 to 8, particle generation is zero. Therefore, blend of 1 part by mass or more of the filler in this Example relative to 100 parts by weight of the vinylidene fluoride-based rubber allows the weight loss to be reduced against the plasma irradiation under the CF₄/O₂ gas mixture atmosphere, while particle generation is being reduced to zero.

As can be clear from the test results of Example 8 listed in Table 9 and the test results of Example 2 listed in Table 4 described above, the weight change rates in the fluorine-contained elastomer compositions in Examples 2 and 8 are almost equal to that of the fluorine-containing elastomer composition in Comparative Example 2, in which the silica particles are blended as the filler, in the plasma irradiation under the CF₄/O₂ gas mixture atmosphere. Therefore, blend of the filler in this Example at a proportion of 10 parts by weight or more and 20 parts by weight or less relative to 100 parts by weight of the vinylidene fluoride-based rubber allows the weight loss to be sufficiently reduced against the plasma irradiation under the CF₄/O₂ gas mixture atmosphere, while particle generation is being reduced to zero.

Subsequently, as can be seen from Table 10, the weight change rates of the fluorine-containing elastomer compositions in Examples 6 to 8 are smaller than that of the fluorine-containing elastomer composition in Comparative Example 4, in which no filler is blended, in the plasma irradiation under the O₂ gas atmosphere. In addition, with respect to the fluorine-containing elastomer compositions in Examples 6 to 8, particle generation is zero. Therefore, blend of 1 part by weight or more of the filler in this Example relative to 100 parts by weight of the vinylidene fluoride-based rubber allows the weight loss to be reduced against the plasma irradiation under the O₂ gas atmosphere, while particle generation is being reduced to zero.

As can be seen from the test results of Example 8 listed in Table 10 and the test results of Example 2 listed in Table 4, the weight change rates of the fluorine-containing elastomer compositions in Examples 2 and 8 are smaller than that of the fluorine-based elastomer composition in Comparative Example 2, in which the silica particles are blended as the filler and smaller than that of the fluorine-based elastomer composition in Comparative Example 4, in which no filler is blended, in the plasma irradiation under the O₂ gas atmosphere. Therefore, blend of the filler in this Example in a range of 10 parts by weight or more and 20 parts by weight or less relative to 100 parts by weight of the vinylidene fluoride-based rubber allows the weight loss to be sufficiently reduced against the plasma irradiation under the O₂ gas atmosphere, while particle generation is being reduced to zero.

### (Action Effect)

Here, the reason why the fluorine-containing elastomer compositions in Examples 1 to 8 can reduce the weight loss under the plasma irradiation environment and the particle generation can be zero or can be as close to zero as possible is considered to be as follows.

Namely, in the fluorine-containing elastomer compositions in Examples 1 to 8, the filler blended into the fluorine-containing elastomer has a particle diameter of 10 nm or more and 100 nm or less. Therefore, the filler is easy to be dispersed into the fluorine-containing elastomer without gaps. Therefore, the filler can easily protect the surface of the fluorine-containing elastomer from plasma.

The silicon particles blended as the filler react with fluorine in the fluorine-containing elastomer to form silicon tetrafluoride gas when the plasma irradiation is performed. Namely, the silicon particles are gasified under the plasma irradiation environment. Therefore, particles are not generated due to the silicon particles.

In addition, the filler has an extremely small particle diameter. Therefore, even in the case where the silicon particles are gasified, a decrease in the weight of the fluorine-containing elastomer composition can be reduced.

Here, the silicon particles including the oxide film is blended in the filler. The irradiation to the silicon particles including the oxide film with the plasma, however, causes the oxide film to be peeled off to expose silicon. The exposed silicon reacts with fluorine in the fluorine-containing elastomer to form silicon tetrafluoride gas. Namely, the exposed silicon is gasified under the plasma irradiation environment. In addition, the particle diameter of the filler is extremely small and thus the oxide film (silica) peeled off by the plasma irradiation is so fine that the peeled oxide film is negligible as the particles. The peeled oxide film is finer than the particle diameter of the silicon particles and thus is gasified by the plasma irradiation and disappears. As a result, the generation of the particles after plasma irradiation reduces as close to zero as possible.

The particle diameter of the filler is 100 nm or less. Therefore, the effect of reducing the weight loss under the plasma irradiation environment can be easily obtained. Namely, the filler having a particle diameter of larger than 100 nm results in larger silicon particles that gasify and thus the effect of reducing weight loss becomes smaller.

In this Example, the particle diameter of the filler is 10 nm or larger. Therefore, the filler is easy to be handled. Namely, the filler having a particle diameter of smaller than 10 nm causes the filler to easily float and thus weighing the filler and the like become less easy. Therefore, the production of the fluorine-containing elastomer composition becomes easier.

In this Example, the filler includes the silicon particles and the silicon particles including the oxide film. Therefore, oxidation of the silicon particles can be accepted during the production of the fluorine-containing elastomer composition. This allows the silicon particles to be easily handled and thus the production of the fluorine-containing elastomer composition to be easier.

Here, in Examples 1 and 3 to 5, the fluorine-containing elastomer compositions include the perfluoroelastomer. The perfluoroelastomer has excellent chemical resistance, solvent resistance, and heat resistance and thus the fluorine-containing elastomer composition in Example 1 is suitable for the sealing material for applications requiring chemical resistance, solvent resistance, and heat resistance.

As described in Examples 1 and 3 to 5, in the case where the filler in this Example is blended at a proportion of 1 part by weight or more and 20 parts by weight or less relative to 100 parts by weight of the perfluoroelastomer when the fluorine-containing elastomer is the perfluoroelastomer, the weight loss can be reduced compared to the fluorine-containing elastomer composition including the same polymer component and blended with no filler. In this case, the effect of reducing the weight loss can be obtained together with the effect of zero particle generation. In addition, in this case, the effects of reducing the weight loss and zero particle generation can be obtained in both plasma irradiation under the CF₄/O₂ gas mixture atmosphere and plasma irradiation under the O₂ gas atmosphere.

As described in Examples 1, 4, and 5, in the case where the filler of this Example is blended at a proportion of 5 parts by weight or more and 20 parts by weight or less relative to 100 parts by weight of perfluoroelastomer, the weight loss can be sufficiently reduced while zero particles are generated in the plasma irradiation under the O₂ gas atmosphere. Therefore, the O-ring (sealing material) made of the fluorine-containing elastomer composition including the filler in this Example in a proportion of 5 parts by weight or more and 20 parts by weight or less relative to 100 parts by weight of the perfluoroelastomer is preferable as the sealing material incorporated into an apparatus installed in an environment where plasma irradiation is performed under the O₂ gas atmosphere.

As described in Examples 1 and 5, in the case where the filler in this Example is blended at a proportion of 10 parts by weight or more and 20 parts by weight or less relative to 100 parts by weight of the perfluoroelastomer, the weight loss can be sufficiently reduced while the generation of particles is being reduced to zero in both plasma irradiation under the CF₄/O₂ gas mixture atmosphere and plasma irradiation under the O₂ gas atmosphere. Therefore, the O-ring (sealing material) made of the fluorine-containing elastomer composition including the filler in this Example in a proportion of 10 parts by weight or more and 20 parts by weight or less relative to 100 parts by weight of the perfluoroelastomer is also preferable as the sealing material for an apparatus installed in an environment where plasma irradiation is performed under the CF₄/O₂ gas mixture atmosphere and as the sealing material incorporated into an apparatus installed in an environment where plasma irradiation is performed under the O₂ gas atmosphere.

On the other hand, in Examples 2 and 6 to 8, the fluorine-containing elastomer composition includes the fluororubber (vinylidene fluoride-based rubber). The vinylidene fluoride-based rubber is less expensive as compared to the perfluoroelastomer. Therefore, in Examples 2 and 6 to 8, the production cost of the fluorine containing elastomer compositions can be reduced as compared to Examples 1 and 3 to 5.

Here, as described in Examples 2 and 6 to 8, in the case where the filler in this Example is blended at a proportion of 1 part by weight or more and 20 parts by weight or less relative to 100 parts by weight of the fluororubber when the fluorine-containing elastomer is the fluororubber, the weight loss can be reduced as compared to the fluorine-containing elastomer composition including the same polymer component and blended with no filler. In this case, the effect of reducing the weight loss can be obtained together with the effect of zero particle generation. In addition, in this case, the effects of reducing the weight loss and zero particle generation can be obtained in both plasma irradiation under the CF₄/O₂ gas mixture atmosphere and plasma irradiation under the O₂ gas atmosphere.

As described in Examples 2 and 8, in the case where the filler in this Example is blended at a proportion of 10 parts by weight or more and 20 parts by weight or less relative to 100 parts by weight of the perfluoroelastomer, the weight loss can be sufficiently reduced while the generation of particles is being reduced to zero in both plasma irradiation under the CF₄/O₂ gas mixture atmosphere and plasma irradiation under the O₂ gas atmosphere.

Therefore, the O-ring (sealing material) made of a fluorine-containing elastomer composition including the filler in this Example in a proportion of 10 parts by weight or more and 20 parts by weight or less relative to 100 parts by weight of the fluororubber is also preferable as the sealing material for an apparatus installed in an environment where plasma irradiation is performed under the CF₄/O₂ gas mixture atmosphere and as the sealing material incorporated into an apparatus installed in an environment where plasma irradiation is performed under the O₂ gas atmosphere.

Here, as described in Examples 1, 2, 5 and 8, in the case where the filler in this Example is blended at a proportion of 10 parts by weight or more and 20 parts by weight or less relative to 100 parts by weight of the fluorine-containing elastomer without regard for the polymer component of the fluorine-containing elastomer, the weight loss can be sufficiently reduced while the generation of particles is being reduced to zero in both plasma irradiation under the CF₄/O₂ gas mixture atmosphere and plasma irradiation under the O₂ gas atmosphere. Therefore, regardless of the polymer component of the fluorine-containing elastomer, the O-ring (sealing material) made of the fluorine-containing elastomer composition including the filler in this Example in a proportion of 10 parts by weight or more and 20 parts by weight or less relative to 100 parts by weight of the fluorine-containing elastomer is also preferable as the sealing material for an apparatus installed in an environment where plasma irradiation is performed under the CF₄/O₂ gas mixture atmosphere and as the sealing material incorporated into an apparatus installed in an environment where plasma irradiation is performed under the O₂ gas atmosphere.

Examples of the apparatus installed in the environment where plasma irradiation is performed under the CF₄/O₂ gas mixture atmosphere and as the apparatus installed in the environment where plasma irradiation is performed under the O₂ gas atmosphere include an apparatus used at the semiconductor production process. More specifically, the examples include an etching apparatus that performs etching on the surface of a substrate such as a silicon wafer and a film-formation apparatus that forms a thin film on the surface of a substrate.

### Modified Example

Here, the filler blended in the fluorine-containing elastomer composition may be silicon particles having a particle diameter of 10 nm or more and 100 nm or less. In other words, the filler does not necessarily include silicon particles including an oxide film as a filler.

When the silicon particles are irradiated with plasma, the silicon particles react with fluorine in the fluorine-containing elastomer to form silicon tetrafluoride gas. Namely, the silicon particles are gasified under the plasma irradiation environment. Therefore, when the filler is determined to be the silicon particles, no particles will be generated in the plasma irradiation environment. The filler has a particle diameter of 10 nm or more and 100 nm or less. Therefore, the filler is easy to be dispersed into the fluorine-containing elastomer without gaps. Therefore, the filler can easily protect the surface of the fluorine-containing elastomer from plasma. In addition, an extremely small particle diameter of the filler allows the weight loss of the fluorine-containing elastomer composition to be reduced even when the silicon particles are gasified.

1. A fluorine-containing elastomer composition comprising:
a fluorine-containing elastomer; and
a filler having a particle diameter of 10 nm or more and 100 nm or less, wherein
the filler is silicon particles and silicon particles including an oxidized film.

2. The fluorine-containing elastomer composition according to claim 1, wherein the fluorine-containing elastomer is a perfluoroelastomer.

3. The fluorine-containing elastomer composition according to claim 2, wherein the fluorine-containing elastomer composition comprises the filler in an amount of 1 part by weight or more and 20 parts by weight or less relative to 100 parts by weight of the perfluoroelastomer.

4. The fluorine-containing elastomer composition according to claim 2, wherein the fluorine-containing elastomer composition comprises the filler in an amount of 5 parts by weight or more and 20 parts by weight or less relative to 100 parts by weight of the perfluoroelastomer.

5. The fluorine-containing elastomer composition according to claim 2, wherein the fluorine-containing elastomer composition comprises the filler in an amount of 10 parts by weight or more and 20 parts by weight or less relative to 100 parts by weight of the perfluoroelastomer.

6. The fluorine-containing elastomer composition according to claim 1, wherein the fluorine-containing elastomer is a fluororubber.

7. The fluorine-containing elastomer composition according to claim 6, wherein the fluorine-containing elastomer composition comprises the filler in an amount of 1 part by weight or more and 20 parts by weight or less relative to 100 parts by weight of the fluororubber.

8. The fluorine-containing elastomer composition according to claim 6, wherein the fluorine-containing elastomer composition comprises the filler in an amount of 10 parts by weight or more and 20 parts by weight or less relative to 100 parts by weight of the fluororubber.

9. The fluorine-containing elastomer composition according to claim 1, wherein the fluorine-containing elastomer composition comprises the filler in an amount of 10 parts by weight or more and 20 parts by weight or less relative to 100 parts by weight of the fluorine-containing elastomer.

10. A sealing material comprising the fluorine-containing elastomer composition as claimed in claim 1.

11. A fluorine-containing elastomer composition comprising:
a fluorine-containing elastomer; and
a filler having a particle diameter of 10 nm or more and 100 nm or less, wherein
the filler is silicon particles.
